(19) United States
(12) Patent Application Publication
(10) Pub. No.: US 2026/0223040 A1
(43) Pub. Date: Jul. 30, 2026

(54) SYSTEM AND METHOD FOR SECURE RANGING SERVICE AND USER EQUIPMENT

(71) Applicant: INNOPEAK TECHNOLOGY, INC., Palo Alto, CA (US)

(72) Inventor: Marcus WONG, Palo Alto, CA (US)

(21) Appl. No.: 19/140,089

(22) PCT Filed: Dec. 20, 2023
(86) PCT No.: PCT/US2023/085032

§ 371 Date: Jun. 17, 2025

Related U.S. Application Data
(60) Provisional application No. 63/434,429, filed on Dec. 21, 2022.

(51) Int. Cl. H04W 64/00; H04W 92/18

(52) U.S. Cl. CPC H04W 64/00; H04W 92/18

(57) ABSTRACT

A method for secure ranging service is executed by an assistant user equipment (UE). A first sidelink between a first UE and the assistant UE and a second sidelink between the assistant UE and a second UE are established in response to initiation of a sidelink ranging session between the first UE and the second UE. A first sidelink ranging session between the first UE and the assistant UE and a second sidelink ranging session between the assistant UE and the second UE are initiated. A binding key is generated. The first sidelink ranging session and the second sidelink ranging session are bound using the binding key. The binding key is transmitted to first UE and to second UE. A first sidelink ranging operation is performed for the first UE and the assistant UE and a second sidelink ranging operation is performed for the second UE and the assistant UE.

### CROSS-REFERENCE TO RELATED APPLICATIONS

This application is a U.S. National Stage entry of International Application No. PCT/US2023/085032, filed Dec. 20, 2023, which claims priority to U.S. Provisional Application No. 63/434,429, filed on Dec. 21, 2022, the entire disclosures of which are incorporated herein by reference.

### BACKGROUND OF DISCLOSURE

### 1. Field of Disclosure

The present disclosure relates to the field of communication systems, and more particularly, to a method for secure ranging service, a user equipment (UE), and a system for secure ranging service.

### 2. Description of Related Art

Ranging and Sidelink Positioning are two new services in 5G. The Ranging service is used to determine the distance between two or more UEs and/or the direction of one UE from another (i.e., reference UE) using the sidelink interface (i.e., PC5 interface). A reference UE supports positioning of target UE, e.g., by transmitting and/or receiving reference signals for positioning, providing positioning-related information, etc. using sidelink. On the other hand, the Sidelink Positioning service is used to position UE to obtain absolute position, relative position, or ranging information. In some cases, when the direct sidelink ranging or positioning operation cannot be performed due to, for example, the distance between two UEs being out of the sidelink reachable area or for other reasons where ranging cannot be performed between two UEs, an assistant UE is used to perform ranging or sidelink positioning between the two UEs.

### Technical Problem

According to the “3GPP Technical Report on Study on Architecture Enhancement to support Ranging based services and sidelink positioning (Release 18)” (3GPP 23.700-86) , the current solution for supporting ranging service using an assistant UE is to establish two separate ranging operations and combine the results at the end.

The current architecture has several drawbacks. The solution relies on two independent and separate ranging operations between a first UE and the assistant UE and between a second UE and the assistant UE. If the ranging result from the assistant UE and the second UE is not correct, for example, if the assistant UE has provided ranging information (e.g., measurement data) that is from another ranging session (e.g., ranging session between the assistant UE and UE3), then the final ranging calculation by the first UE would be incorrect. The final ranging calculation is not useful to the first UE if the interim (or intermediate) ranging result between the assistant UE and the second UE cannot be assured that it comes from the same ranging session between the first UE and the second UE.

The interim ranging results between the assistant UE and the second UE in the current solution may or may not be protected. One of the reasons for requiring an assistant UE in the ranging operation between the first UE and the second UE is that the first UE and the second UE are not able to perform ranging operation directly. This could be due to the distance between the first UE and the second UE, which makes the sidelink interface between them inaccessible or unreliable. In such cases, the interim ranging result needs to be sent from the second UE to the first UE using a UE-to-UE relay. However, depending on the protection profile or security policy, there is no assurance that the interim ranging result sent from the second UE to the first UE is valid or is protected.

### SUMMARY

In a first aspect, an embodiment of the invention provides a method for secure ranging service for execution by a user equipment (UE) that serves as an assistant UE, comprising:
establishing a first sidelink between a first UE and the assistant UE and a second sidelink between the assistant UE and a second UE in response to initiation of a sidelink ranging session between the first UE and the second UE, wherein the first sidelink and second sidelink are secured using credentials configured in the first UE, assistant UE, and second UE respectively;
initiating a first sidelink ranging session between the first UE and the assistant UE and a second sidelink ranging session between the assistant UE and the second UE;
generating a binding key;
binding the first sidelink ranging session and the second sidelink ranging session using the binding key;
sending the binding key to a first UE and to a second UE;
performing a first sidelink ranging operation for the first UE and the assistant UE and a second sidelink ranging operation for the second UE and the assistant UE;
obtaining a second interim ranging result of the second sidelink ranging operation; and
transmitting the second interim ranging result to the first UE through the first sidelink ranging session that is bound with the second sidelink ranging session, wherein the second interim ranging result of the second sidelink ranging operation and a first interim ranging result of the first sidelink ranging operation are used for deriving of a final ranging result for the first UE and the second UE.

In a second aspect, an embodiment of the invention provides a user equipment (UE) comprising a processor configured to call and run a computer program stored in a memory, to cause a device in which the chip is installed to execute the disclosed method and any combination of embodiments of the disclosed method.

In a third aspect, an embodiment of the invention provides a system for secure ranging service comprising:
a first user equipment (UE) configured for requesting initiation of a sidelink ranging session for the first UE;
a second UE configured for serving as a target UE for the sidelink ranging session; and
an assistant UE configured for establishing a first sidelink between the first UE and the assistant UE wherein the first sidelink is secured using credentials configured in the first UE and the assistant UE, and a second sidelink between the assistant UE and a second UE in response to initiation of the sidelink ranging session between the first UE and the second UE wherein the second sidelink is secured using credentials configured in the assistant UE and the second UE;
wherein the first UE or the assistant UE initiates a first sidelink ranging session between the first UE and the assistant UE;
the assistant UE initiates a second sidelink ranging session between the assistant UE and the second UE;
the assistant UE generates a binding key;
the assistant UE binds the first sidelink ranging session and the second sidelink ranging session using the binding key;
the assistant UE sends the binding key to the first UE and to the second UE;
the first UE or the assistant UE performs a first sidelink ranging operation for the first UE and the assistant UE;
the second UE or the assistant UE performs a second sidelink ranging operation for the second UE and the assistant UE;
the assistant UE obtains a second interim ranging result of the second sidelink ranging operation;
the assistant UE uses the binding key and the second interim ranging result to generate a message authentication code (MAC) of the second interim ranging result; and
the assistant UE transmits the message authentication code and the second interim ranging result to the first UE, wherein the second interim ranging result of the second sidelink ranging operation and a first interim ranging result of the first sidelink ranging operation are used for deriving of a final ranging result for the first UE and the second UE;
the first UE receives the message authentication code and the second interim ranging result and uses the message authentication code to validate the second interim ranging result; and
the first UE uses the first interim ranging result and the second interim ranging result to derive the final ranging result for the first UE and the second UE when the second interim ranging result passes validation.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view of a telecommunication system.

FIG. 2 illustrates a schematic view showing UEs involved in sidelink ranging service.

FIG. 3 illustrates a schematic view showing an embodiment of the disclosed method for secure ranging service.

FIG. 4 illustrates a schematic view showing an embodiment of the disclosed method for secure ranging service.

FIG. 5 illustrates a schematic view showing an embodiment of the disclosed method for secure ranging service.

FIG. 6 illustrates a schematic view showing an embodiment of the disclosed method for secure ranging service.

FIG. 7 illustrates a schematic view showing an example of a topology of UEs.

FIG. 8 illustrates a schematic view showing an example of a topology of UEs.

FIG. 9 illustrates a schematic view showing an example of a topology of UEs.

FIG. 10 illustrates a schematic view showing an example of a topology of UEs.

FIG. 11 illustrates a schematic view showing an example of a topology of UEs.

FIG. 12 illustrates a schematic view showing a chip or executing the disclosed method in a UE.

FIG. 13 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

This invention proposes a method to link the two independent ranging sessions between a first UE and an assistant UE and between the assistant UE and a second UE. To prevent the interim ranging results between the assistant UE and the second UE from being modified or altered, security protection is provided to the interim ranging result being sent to the first UE.

To ensure that the interim ranging result comes from the same ranging session that involves the first UE, the second UE, and the assistant UE, the interim ranging result is also cryptographically bound to the session identifier which is bound to a ranging session identifier between the first UE and the second UE, a ranging session identifier between the first UE and the assistant UE, and a ranging session identifier between the assistant UE and the second UE.

After the first UE determines that the interim ranging results sent from the second UE are from the same ranging session between the first UE and the second UE and that the interim ranging results have been protected, the first UE uses the interim ranging result between the second UE and the assistant UE and the ranging result between the first UE and the assistant UE for the final ranging calculation.

Embodiments of the disclosure relate to the field of New Radio (NR) sidelink resource allocation procedure in both licensed and unlicensed band and address issues regarding semi-static channel access for SL-U.

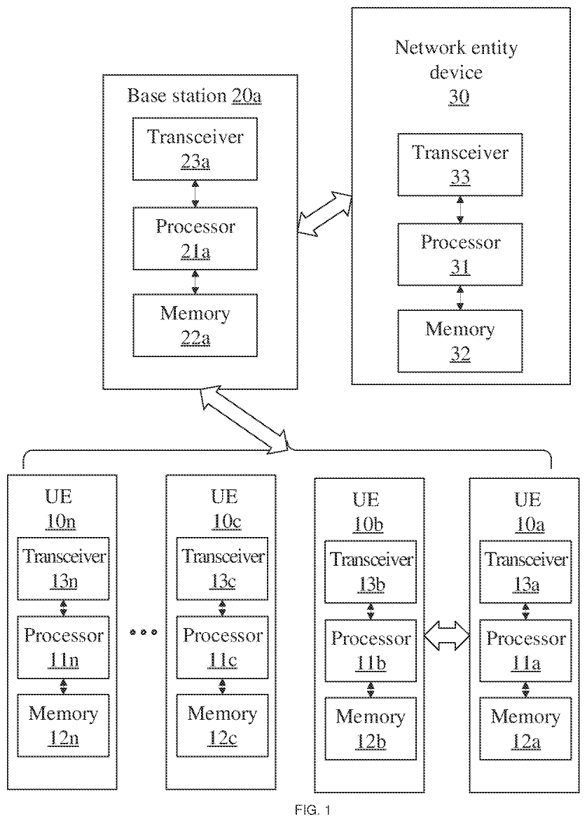

With reference to FIG. 1, a telecommunication system including user equipment (UE) 10a-10n, a base station (BS) 20a, and a network entity device 30 executes the disclosed method according to an embodiment of the present disclosure. FIG. 1 is shown for illustrative not limiting, and the system may comprise more UEs, BSs, and core network (CN) entities. Connections between devices and device components are shown as lines and arrows in the FIGs.

The UE 10a may include a processor 11a, a memory 12a, and a transceiver 13a. The UE 10b may include a processor 11b, a memory 12b, and a transceiver 13b. The UE 10c may include a processor 11c, a memory 12c, and a transceiver 13c. The UE 10n may include a processor 11n, a memory 12n, and a transceiver 13n. The base station 20a may include a processor 21a, a memory 22a, and a transceiver 23a. The network entity device 30 may include a processor 31, a memory 32, and a transceiver 33. Each of the processors 11a-11n, 21a, and 31 may be configured to implement proposed functions, procedures and/or methods described in the description. Layers of radio interface protocol may be implemented in the processors 11a-11n, 21a, and 31. Each of the memory 12a-12n, 22a, and 32 operatively stores a variety of programs and information to operate a connected processor. Each of the transceivers 13a-13n, 23a, and 33 is operatively coupled with a connected processor, and transmits and/or receives radio signals or wireline signals. One of UEs 10a-10n may be in communication with another UE through a sidelink. The base station 20a may be an eNB, a gNB, or one of other types of radio nodes, and may configure radio resources for the UE 10a and UE 10b.

Each of the processors 11a-11n, 21a, and 31 may include an application-specific integrated circuit (ASICs), other chipsets, logic circuits and/or data processing devices. Each of the memory 12a-12n, 22a, and 32 may include read-only memory (ROM), a random access memory (RAM), a flash memory, a memory card, a storage medium and/or other storage devices. Each of the transceivers 13a-13n, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes location management function (LMF), location retrieval function (LRF), gateway mobile location center (GMLC), user plane function (UPF), session management function (SMF), access and mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a-10n. An example of the base station in the description may include the base station 20a. Sidelink (SL) transmission of a control signal or data may be a transmission operation from a UE to another UE through a sidelink interface, such as ProSe PC5 . Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

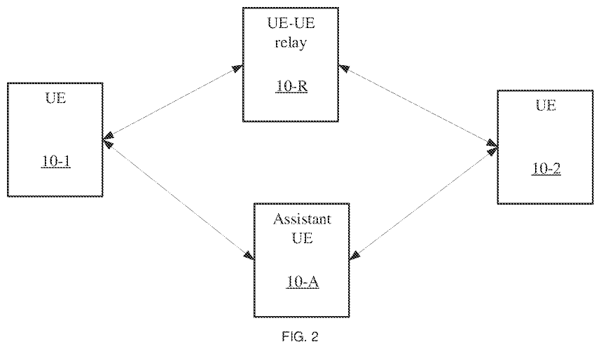

With reference to FIG. 2, a first UE 10-1 wants to determine the distance between the first UE 10-1 and a second UE 10-2 using ranging service. Examples of the first UE 10-1 and the second UE 10-2 may comprise UE 10a and UE 10n. The first UE 10-1, the second UE 10-2, and an assistant UE 10-A are assumed to be capable of sidelink communication, which allows them to communicate with other UEs through PC5 to support V2X, ProSe, and ranging/sidelink positioning services. An example of the assistant UE 10-A may comprise a UE (e.g., UE 10b) between the UE 10a and UE 10n.

In the example, the first UE 10-1 functions as an initiator of a ranging/sidelink positioning service, and the second UE 10-2 serves as a target UE. A target UE is a UE whose distance, direction and/or position is measured with the support from one or multiple SL Reference UEs using Sidelink in the Ranging based service and Sidelink positioning. The first UE 10-1 may serve as a reference UE. Note that the disclosure is not limited to the example, the second UE 10-2 or another UE can operate as an initiator of a ranging/sidelink positioning service, and the first UE 10-1 or another UE can serve as a target UE.

The assistant UE 10-A supports Ranging/Sidelink Positioning between a SL Reference UE and a Target UE over PC5 , when the direct Ranging/Sidelink positioning between the SL Reference UE and Target UE cannot be supported. The measurement/result of Ranging/Sidelink Positioning between the assistant UE 10-A and the SL Reference UE and that between the assistant UE 10-A and the Target UE are determined and used to derive the Ranging/Sidelink Positioning result between Target UE and SL Reference UE.

The initiator may be a sidelink (SL) positioning client UE. In an alternative embodiment, an SL positioning client UE may be a third-party UE, other than SL Reference UE and Target UE, which initiates ranging/sidelink positioning service request on behalf of the application residing on the client UE.

Note that the SL Positioning Client UE does not have to support ranging/sidelink positioning capability, but a communication between the SL Positioning Client UE and SL Reference UE/Target UE has to be established, either via PC5 or via 5GC, for the transmission of the service request and the result of the ranging/sidelink positioning service.

A system for secure ranging service comprises the first UE 10-1, the second UE 10-2, and the assistant UE 10-A. In some embodiments of the disclosure, the assistant UE are provisioned with parameters needed for ranging/Sidelink Positioning services. In some embodiments of the disclosure, the parameters include parameters needed to discover other UEs that are capable of ranging and are authorized for ranging services. In some embodiments of the disclosure, the parameters include security parameters to secure the PC5 links for the first UE, the second UE, and the assistant UE.

The assistant UE 10-A, first UE 10-1, and second UE 10-2 performs sidelink device discovery. For example, the first UE 10-1 and second UE 10-2 discovers the assistant UE 10-A, and the assistant UE 10-A discovers the first UE 10-1 and second UE 10-2. In some embodiments of the disclosure, at least one of the assistant UE 10-A, first UE 10-1, and second UE 10-2 performs sidelink device discovery through a UE-to-UE relay.

The first UE 10-1 is configured for requesting initiation of a sidelink ranging session for the first UE 10-1. The second UE 10-2 is configured for serving as a target UE for the sidelink ranging session. The assistant UE 10-A is configured for establishing a first sidelink between the first UE 10-1 and the assistant UE 10-A and a second sidelink between the assistant UE 10-A and the second UE 10-2 in response to initiation of the sidelink ranging session between the first UE 10-1 and the second UE 10-2. The first sidelink and second sidelink are secured using credentials configured in the first UE 10-1, assistant UE 10-A, and second UE 10-2 respectively. The first sidelink and second sidelink may be secured by using the credentials to encrypt the content (e.g., payload) conveyed in the first sidelink and second sidelink or to sign the first sidelink and second sidelink. SR5 is the reference point between the Sidelink (SL) Positioning and Ranging function in UEs. In the description, the sidelink ranging session may be carried over the SR5 reference point. PC5 is the reference point between the UEs. PC5 also supports the Sidelink Positioning and Ranging operation. SR5 may be carried over the PC5 reference point.

In some embodiments of the disclosure, security is established for a first PC5 link between the first UE and the UE-to-UE relay and for a second PC5 link between the UE-to-UE relay and the second UE.

The first UE 10-1 or the assistant UE 10-A initiates a first sidelink ranging session between the first UE 10-1 and the assistant UE 10-A. The assistant UE 10-A initiates a second sidelink ranging session between the assistant UE 10-A and the second UE 10-2. In some embodiments of the disclosure, the first UE and the assistant UE use a first encryption key to protect the first sidelink between the first UE and the assistant UE. The second UE and the assistant UE use a second encryption key to protect the second sidelink between the assistant UE and a second UE.

The assistant UE 10-A generates a binding key. The assistant UE 10-A binds the first sidelink ranging session and the second sidelink ranging session using the binding key. The assistant UE 10-A transmits the binding key to the first UE and to second UE. In some embodiments of the disclosure, the binding key is a random number or a cryptographic hash of the first encryption key and the second encryption key. In some embodiments of the disclosure, the binding comprises:
using the binding key to encrypt content of the first sidelink ranging session and content of the second sidelink ranging session; or
using the binding key and a cryptographic hash to sign the first sidelink ranging session and the second sidelink ranging session.

In some embodiments of the disclosure, the cryptographic hash is a cryptographic hash of a session identifier (ID) of the first sidelink ranging session between the first UE and the assistant UE, a session ID of the second sidelink ranging session between the assistant UE and the second UE, and a session ID of a main sidelink ranging session between the first UE and the second UE.

The first UE 10-1 or the assistant UE 10-A performs a first sidelink ranging operation for the first UE 10-1 and the assistant UE 10-A. The second UE 10-2 or the assistant UE 10-A performs a second sidelink ranging operation for the second UE 10-2 and the assistant UE 10-A.

The assistant UE 10-A obtains a second interim ranging result of the second sidelink ranging operation. The assistant UE 10-A uses the binding key and the second interim ranging result to generate a message authentication code (MAC) of the second interim ranging result.

The assistant UE 10-A transmits the message authentication code and the second interim ranging result to the first UE 10-1. The second interim ranging result of the second sidelink ranging operation and a first interim ranging result of the first sidelink ranging operation are used for deriving of a final ranging result for the first UE 10-1 and the second UE 10-2.

The first UE 10-1 receives the message authentication code and the second interim ranging result and uses the message authentication code to validate the second interim ranging result.

The first UE 10-1 uses the first interim ranging result and the second interim ranging result to derive the final ranging result for the first UE 10-1 and the second UE 10-2 when the second interim ranging result passes validation.

An embodiment of the disclosed method for secure ranging service comprises operations of the assistant UE 10-A.

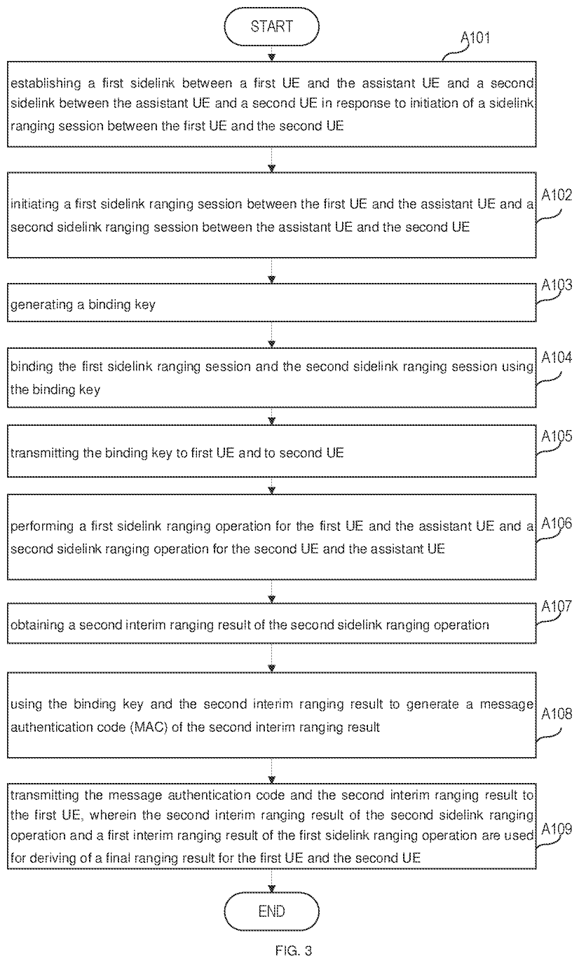

With reference to FIG. 3, the assistant UE 10-A establishes a first sidelink between a first UE 10-1 and the assistant UE 10-A and a second sidelink between the assistant UE 10-A and a second UE 10-2 in response to initiation of a sidelink ranging session between the first UE 10-1 and the second UE 10-2 (A101). The first sidelink and second sidelink are secured using credentials configured in the first UE 10-1, assistant UE 10-A, and second UE 10-2 respectively.

The assistant UE 10-A initiates a first sidelink ranging session between the first UE 10-1 and the assistant UE 10-A and a second sidelink ranging session between the assistant UE 10-A and the second UE 10-2 (A102). The assistant UE 10-A generates a binding key (A103) and binds the first sidelink ranging session and the second sidelink ranging session using the binding key (A104). The assistant UE 10-A transmits the binding key to first UE and to second UE (A105).

The assistant UE 10-A performs a first sidelink ranging operation for the first UE 10-1 and the assistant UE 10-A and a second sidelink ranging operation for the second UE 10-2 and the assistant UE 10-A (A106).

The assistant UE 10-A obtains a second interim ranging result of the second sidelink ranging operation (A107) and uses the binding key and the second interim ranging result to generate a message authentication code (MAC) of the second interim ranging result (A108).

The assistant UE 10-A transmits the message authentication code and the second interim ranging result to the first UE 10-1, wherein the second interim ranging result of the second sidelink ranging operation and a first interim ranging result of the first sidelink ranging operation are used for deriving of a final ranging result for the first UE 10-1 and the second UE 10-2 (A109).

Note that the method for secure ranging service utilizes multiple protection schemes, including security or PC5 link, binding of ranging session, and data integrity protection for interim ranging results. The UEs may utilize all or some of the protection schemes. For example, MAC of the second interim ranging result can be optional.

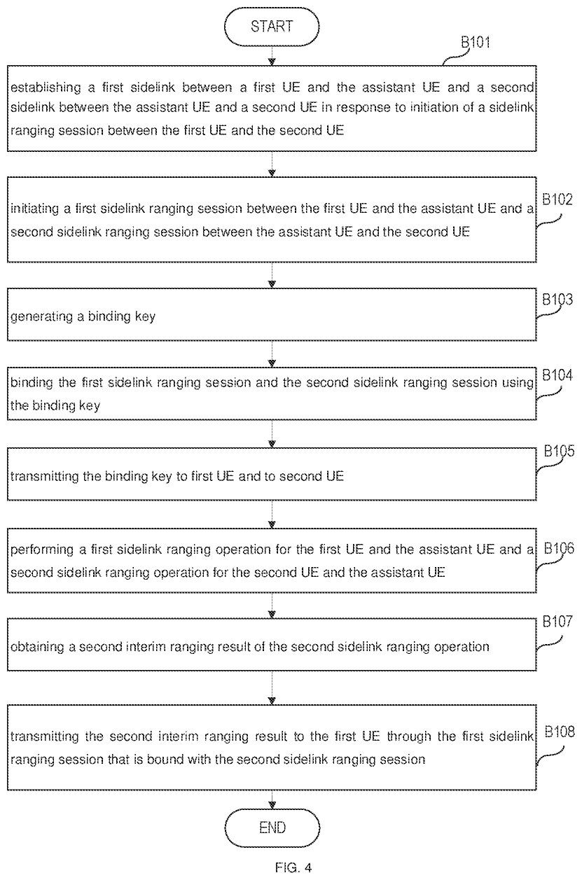

With reference to FIG. 4, an embodiment of the disclosed method for secure ranging service is provided in the following.

The assistant UE 10-A executes a method for secure ranging service. The assistant UE 10-A establishes a first sidelink between a first UE 10-1 and the assistant UE 10-A and a second sidelink between the assistant UE 10-A and a second UE 10-2 in response to initiation of a sidelink ranging session between the first UE 10-1 and the second UE 10-2 (B101). The first sidelink and second sidelink are secured using credentials configured in the first UE 10-1, assistant UE 10-A, and second UE 10-2 respectively.

The assistant UE 10-A initiates a first sidelink ranging session between the first UE 10-1 and the assistant UE 10-A and a second sidelink ranging session between the assistant UE 10-A and the second UE 10-2 (B102). The assistant UE 10-A generates a binding key (B103). The assistant UE 10-A binds the first sidelink ranging session and the second sidelink ranging session using the binding key (B104) and transmits the binding key to first UE and to second UE (B105).

The assistant UE 10-A performs a first sidelink ranging operation for the first UE 10-1 and the assistant UE 10-A and a second sidelink ranging operation for the second UE 10-2 and the assistant UE 10-A (B106). The assistant UE 10-A obtains a second interim ranging result of the second sidelink ranging operation (B107) and transmits the second interim ranging result to the first UE 10-1 through the first sidelink ranging session that is bound with the second sidelink ranging session (B108). The second interim ranging result of the second sidelink ranging operation and a first interim ranging result of the first sidelink ranging operation are used for deriving of a final ranging result for the first UE 10-1 and the second UE 10-2.

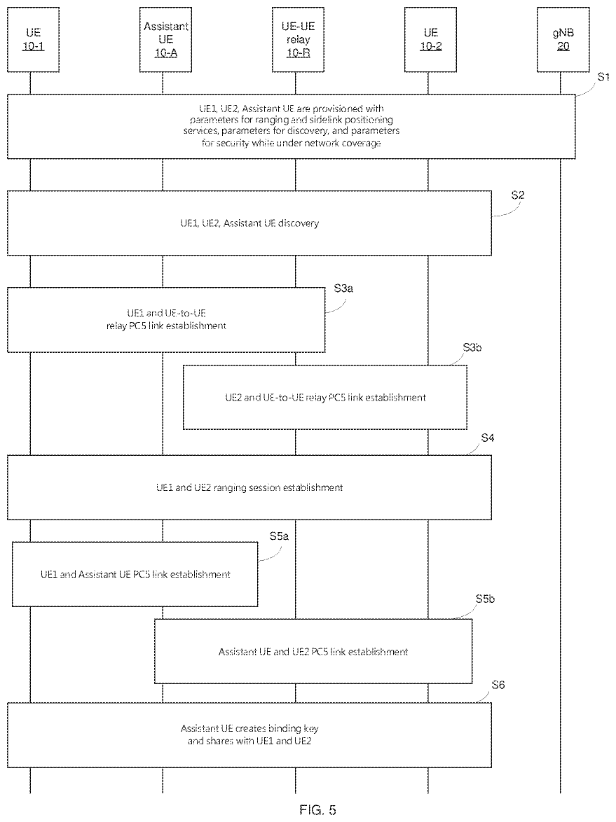

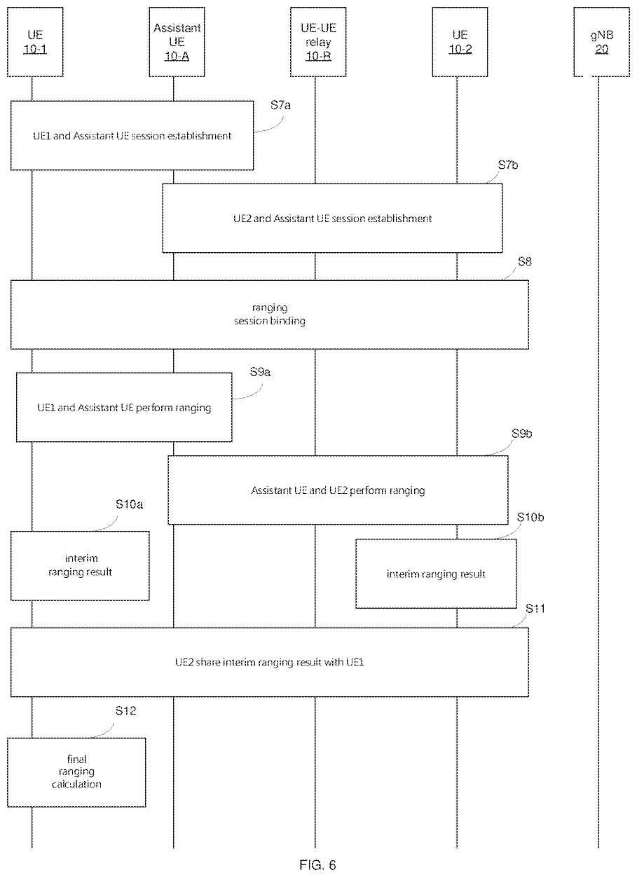

With reference to FIG. 5 and FIG. 6, an embodiment of the disclosed method for secure ranging service is provided in the following.

Step S1: While still under the 5G network coverage, the first UE 10-1, the second UE 10-2, and the assistant UE 10-A are provisioned with parameters needed for ranging/Sidelink Positioning services. For example, a gNB 20 (e.g., the base station 20b) provides the parameters. These parameters include those needed to discover other UEs that are capable of ranging and are authorized for ranging services. The parameters may also include security parameters to secure the PC5 links for the UEs, depending on the security policy on the protection of PC5 interface.

Step S2: The first UE 10-1, the second UE 10-2, and the assistant UE 10-A discover each other using the discovery parameters provisioned in Step S1. It is also assumed that the first UE 10-1, the second UE 10-2, and assistant UE 10-A have been authenticated with each other and have been validated as being authorized to perform ranging operations. At this point, the assistant UE 10-A is not aware that it will be used as an assistant UE 10-A.

The discovery process may involve a UE-to-UE relay 10-R (e.g., UE 10c) if the first UE 10-1 and the second UE 10-2 are unable to discover each other directly. When the UE-to-UE relay 10-R is used, the UE-to-UE relay 10-R is also discovered by the first UE 10-1, the second UE 10-2, and the assistant UE 10-A.

Step S3a, S3b: The first UE 10-1 and the second UE 10-2 initiate a PC5 link. In case the first UE 10-1 and the second UE 10-2 are not reachable via direct sidelink (e.g., PC5 ), a UE-to-UE relay 10-R is used. PC5 link establishment procedures are performed between the first UE 10-1 and UE-to-UE relay 10-R, and between UE-to-UE relay 10-R and the second UE 10-2 respectively. In the PC5 link establishment procedure, security is established for a PC5 link between the first UE 10-1 and UE-to-UE relay 10-R, and for a PC5 link between UE-to-UE relay 10-R and the second UE 10-2 respectively, where both connections can be protected.

Step S4: The first UE 10-1 and the second UE 10-2 initiate a ranging session. If the distance between the first UE 10-1 and the second UE 10-2 is not within the range where sidelink (e.g., PC5 connection) can be established directly, a UE-to-UE relay 10-R is used. If the first UE 10-1 and the second UE 10-2 determine that they are not able to perform ranging operations directly, for example, due to distance, the first UE 10-1 and the second UE 10-2 use the assistant UE 10-A to establish separate ranging sessions between the first UE 10-1 and the assistant UE 10-A, and between the assistant UE 10-A and the second UE 10-2 respectively. The ranging session is identified by a ranging identifier (e.g., Ranging_Session_ID).

Step S5a and S5b: PC5 link establishment procedures are performed between the first UE 10-1 and the assistant UE 10-A, and between the assistant UE 10-A and the second UE 10-2 respectively. In the PC5 link establishment procedure, security is established between the first UE 10-1 and assistant UE 10-A, and between assistant UE 10-A and the second UE 10-2 respectively, where both connections can be protected. In the PC5 link establishment procedure, security is established between the first UE 10-1 and UE-to-UE relay 10-R, and between UE-to-UE relay 10-R and the second UE 10-2 respectively, where both connections can be protected. For example, the first UE 10-1 and the assistant UE 10-A generate and use encryption key the first UE 10-1 AssistantUE_key to protect the connection (i.e., the PC5 link) between the first UE 10-1 and the assistant UE 10-A, and the second UE 10-2 and the assistant UE 10-A generate and use encryption key the second UE 10-2_AssistantUE_key to protect the connection (i.e., the PC5 link) between the second UE 10-2 and the assistant UE 10-A.

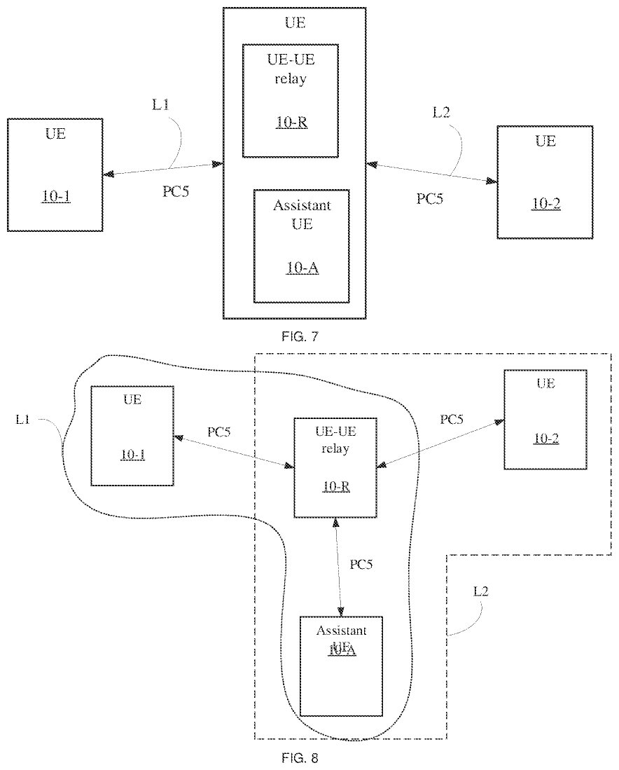

With reference to FIG. 7, in an embodiment, the assistant UE 10-A and the UE-to-UE relay 10-R may be the same UE. Note that the assistant UE 10-A and the UE-to-UE relay 10-R can be two separate UEs. Either of both of the first UE 10-1 and the second UE 10-2 may access the assistant UE 10-A through the UE-to-UE relay 10-R. If at least one of the first UE 10-1 and the second UE 10-2 access the assistant UE 10-A through the UE-to-UE relay 10-R, PC5 link establishment procedures are performed between the assistant UE 10-A and the UE-to-UE relay 10-R. In the PC5 link establishment procedure, security is established between the assistant UE 10-A and the UE-to-UE relay 10-R. The UE-to-UE relay 10-R and the assistant UE 10-A generate and use encryption key Relay_AssistantUE_key to protect the connection between the UE-to-UE relay 10-R and the assistant UE 10-A.

Step S6: assistant UE 10-A creates a binding key (e.g., Binding_Key) that will be used to bind the ranging sessions between the first UE 10-1 and assistant UE 10-A, between assistant UE 10-A and the second UE 10-2, and between the first UE 10-1 and the second UE 10-2 together. The binding key may be a cryptographic key and will also be used to protect the interim ranging result between the assistant UE 10-A and the second UE 10-2 that will be sent from the second UE 10-2 to the first UE 10-1. The binding key can be created using a number of different methods. For example, the binding key may be a cryptographic hash of the keys generated previously in Step S5a and S5b, hash (UE1_AssistantUE_key and AssistantUE_UE2_key), keys generated by the assistant UE 10-A (e.g., a random number), or others. The assistant UE 10-A sends the binding key to the first UE 10-1 and the second UE 10-2 respectively.

Step S7a and S7b: Ranging sessions between the first UE 10-1 and the assistant UE 10-A, and between the assistant UE 10-A and the second UE 10-2 are established respectively. Each ranging session is identified by a ranging identifier (e.g., Ranging_Session_ID).

Step S8: The assistant UE 10-A binds the ranging sessions for the first UE 10-1.

With reference to FIG. 7, in an embodiment, the assistant UE 10-A and the UE-to-UE relay 10-R may be the same UE. LI represents the first sidelink ranging session, and L2 represents the second sidelink ranging session. The first UE 10-1 establishes a PC5 link with the second UE 10-2 through the UE-to-UE relay 10-R. The second UE 10-2 establishes a PC5 link with the first UE 10-1 through the UE-to-UE relay 10-R. The first UE 10-1 initiates the first sidelink ranging session L1 with the assistant UE 10-A. The second UE 10-2 initiates the second sidelink ranging session L2 with the assistant UE 10-A. The assistant UE 10-A binds the first sidelink ranging session L1 and the second sidelink ranging session L2 using the binding key.

With reference to FIG. 8, in an embodiment, LI represents the first sidelink ranging session, and L2 represents the second sidelink ranging session. The first UE 10-1 establishes a PC5 link with the assistant UE 10-A through the UE-to-UE relay 10-R. The second UE 10-2 establishes a PC5 link with the assistant UE 10-A through the UE-to-UE relay 10-R. The first UE 10-1 initiates the first sidelink ranging session L1 with the assistant UE 10-A. The second UE 10-2 initiates the second sidelink ranging session L2 with the assistant UE 10-A. The assistant UE 10-A binds the first sidelink ranging session L1 and the second sidelink ranging session L2 using the binding key.

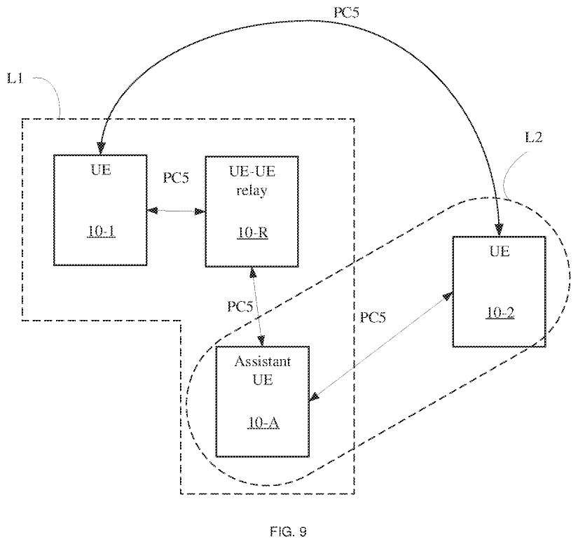

With reference to FIG. 9, in an embodiment, LI represents the first sidelink ranging session, and L2 represents the second sidelink ranging session. The first UE 10-1 establishes a PC5 link with the assistant UE 10-A through the UE-to-UE relay 10-R. The second UE 10-2 establishes a PC5 link with the assistant UE 10-A. The first UE 10-1 initiates the first sidelink ranging session L1 with the assistant UE 10-A. The second UE 10-2 initiates the second sidelink ranging session L2 with the assistant UE 10-A. The assistant UE 10-A binds the first sidelink ranging session L1 and the second sidelink ranging session L2 using the binding key.

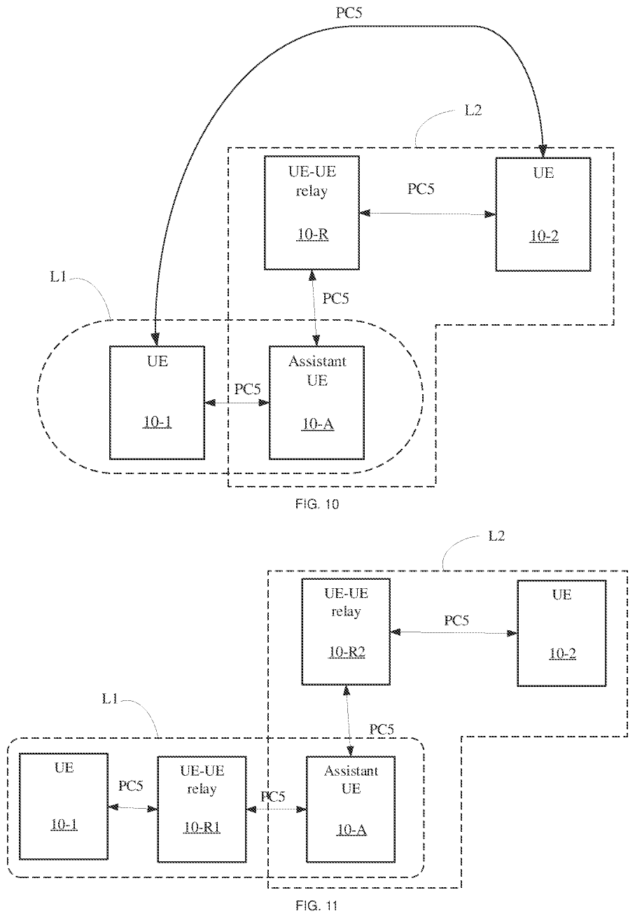

With reference to FIG. 10, in an embodiment, L1 represents the first sidelink ranging session, and L2 represents the second sidelink ranging session. The first UE 10-1 establishes a PC5 link with the assistant UE 10-A. The second UE 10-2 establishes a PC5 link with the assistant UE 10-A through the UE-to-UE relay 10-R. The first UE 10-1 initiates the first sidelink ranging session Ll with the assistant UE 10-A. The second UE 10-2 initiates the second sidelink ranging session L2 with the assistant UE 10-A. The assistant UE 10-A binds the first sidelink ranging session L1 and the second sidelink ranging session L2 using the binding key.

With reference to FIG. 11, in an embodiment, L1 represents the first sidelink ranging session, and L2 represents the second sidelink ranging session. The first UE 10-1 establishes a PC5 link with the assistant UE 10-A through a UE-to-UE relay 10-R1. The second UE 10-2 establishes a PC5 link with the assistant UE 10-A through a UE-to-UE relay 10-R2. The first UE 10-1 initiates the first sidelink ranging session L1 with the assistant UE 10-A. The second UE 10-2 initiates the second sidelink ranging session L2 with the assistant UE 10-A. The assistant UE 10-A binds the first sidelink ranging session L1 and the second sidelink ranging session L2 using the binding key.

Since there may be more than one ranging session between the first UE 10-1 and the assistant UE 10-A, for example, in the case there is an ongoing ranging session between the first UE 10-1 and another UE (e.g., UE3 that is not shown in the example call flow), to avoid data corruption between the two ongoing ranging sessions (e.g., ranging sessions between the first UE 10-1 and the second UE 10-2, and between the first UE 10-1 and UE3), this particular ranging session between the first UE 10-1 and the assistant UE 10-A and the ranging session between second UE 10-2 and the assistant UE 10-A are bound to the main ranging session under which the ranging session between the first UE 10-1 and the assistant UE 10-A is created.

Binding of ranging sessions can be done using the binding key created in Step S6 and shared with the first UE 10-1 and the second UE 10-2. The assistant UE 10-A may use at least one of two schemes to bind the ranging sessions for the first UE 10-1 using the binding key. A first scheme is encrypting the content (e.g., payload) of the first sidelink ranging session between the first UE 10-1 and the assistant UE 10-A and the second sidelink ranging session between the assistant UE 10-A and the second UE 10-2. The encrypting may comprise one of symmetric encryption or asymmetric encryption.

This first scheme involves transforming (i.e., encrypting) the content in the ranging sessions into an unreadable format using a cryptographic algorithm and a secret key (i.e., the binding key). Only a receiving UE with the correct key can decrypt and access the original content.

The second scheme is signing the first sidelink ranging session between the first UE 10-1 and the assistant UE 10-A and the second sidelink ranging session between the assistant UE 10-A and the second UE 10-2. This second scheme involves attaching a digital signature to the ranging sessions using a cryptographic hash function and a private key (e.g., the binding key). The signature acts like a fingerprint, verifying the authenticity and integrity of the ranging sessions and its content. Any tampering with the link or content will invalidate the signature.

For example, the ranging sessions may be bound by creating a cryptographic hash of UE1_AssistantUE_SessionID, AssistantUE_UE2_Session ID, UE1_UE2_SessionID using the binding key. The first UE 10-1_AssistantUE SessionID is the session ID of the first sidelink ranging session between the first UE 10-1 and the assistant UE 10-A. AssistantUE UE2 Session ID is the session ID of the second sidelink ranging session between the assistant UE 10-A and the second UE. UE1 UE2 SessionID is the session ID of the main sidelink ranging session between the first UE 10-1 and the second UE 10-2.

Step S9a and S9b: The first UE 10-1 and the assistant UE 10-A perform ranging operations, while the assistant UE 10-A and the second UE 10-2 perform ranging operations.

Step S10a and S10b: Based on the ranging operations in Step S9a and Step S9b, the first UE 10-1 and the second UE 10-2 derive interim ranging results respectively.

Step S11: The second UE 10-2 uses the binding key to create a message authentication code (MAC) using the interim ranging result and the binding of the session (i.e., session binding is created in Step S8) and sends both the interim ranging result and the message authentication code to the first UE 10-1. The message authentication code is used to protect the interim ranging result, irrespective of whether there is security protection over the PC5 link between the first UE 10-1 and the second UE 10-2 (and in the case there is a UE-to-UE relay 10-R being used between the first UE 10-1 and the second UE 10-2, the PC5 links between the first UE 10-1 and UE-to-UE relay 10-R and between UE-to-UE relay 10-R and the second UE 10-2). Since the security policy for protecting the ranging service may be different from the security policy for protecting PC5 interface or security policy for protecting other services over PC5 interface, there is no guarantee that PC5 security is applied in every case.

Step S12: The first UE 10-1 receives the interim ranging result and the message authentication code from the second UE 10-2. the first UE 10-1 uses its own binding key to validate the message authentication code to ensure that the interim ranging result has not been tampered with and that the interim ranging result is from the current ranging session involving the first UE 10-1, the second UE 10-2, and the assistant UE 10-A. Finally, the first UE 10-1 uses the interim ranging results from the second UE 10-2 and from the ranging session between the first UE 10-1 and the assistant UE 10-A to calculate the final ranging result. The final ranging result represents a range measurement between the first UE 10-1 and the second UE 10-2.

To encrypt the interim ranging result, an MAC algorithm that uses a symmetric key (e.g., the binding key) and the plain text interim ranging result can be used. The MAC algorithm then generates authentication tags of a fixed length by processing the interim ranging result. The resulting computation is the MAC of the interim ranging result.

The assistant UE 10-A appends MAC to the interim ranging result and transmits the MAC and the interim ranging result to the receiver (e.g., the first UE 10-1). The receiver (e.g., the first UE 10-1) computes the MAC using the same algorithm. If the resulting MAC the receiver (e.g., the first UE 10-1) obtains from the MAC computing equals the one sent by the sender (e.g., the second UE 10-2), the interim ranging result is verified as authentic, legitimate, and not tampered with.

In effect, MAC uses a secure key only known to the sender (e.g., the second UE 10-2) and the receiver (e.g., the first UE 10-1). Without this information, the receiver (e.g., the first UE 10-1) will not be able to open, use, read, or even receive the data being sent. If the data is altered between the time the sender (e.g., the second UE 10-2) initiates the transfer and when the receiver (e.g., the first UE 10-1) receives it, the MAC information will also be affected.

Therefore, when the receiver attempts to verify the authenticity of the data, the key will not work, and the end result will not match that of the sender (e.g., the second UE 10-2). When this kind of discrepancy is detected, the data packet can be discarded, protecting the receiver (e.g., the first UE 10-1). Examples of the MAC algorithm may comprise one-time MAC, Carter-Wegman MAC, and Keyed-Hash Message Authentication Code (HMAC).

By implementing a security mechanism to protect interim ranging results during the ranging service between two UEs employing an assistant UE 10-A, the accuracy, reliability, and security of the ranging results for UEs utilizing the ranging service can be ensured. Cryptographically binding the interim ranging result to the session and providing protection prevents any potential corruption of the interim ranging result. This is particularly crucial when the assistant UE 10-A is engaged in multiple ranging sessions with more than one UE.

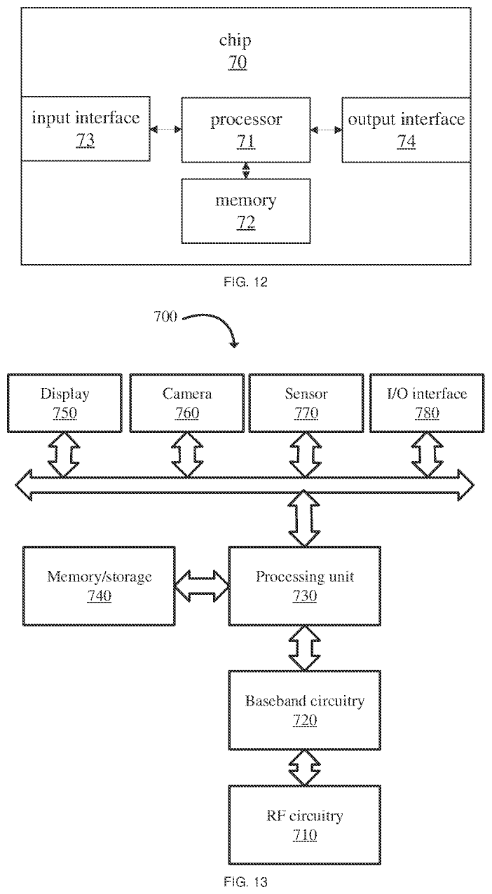

With reference to FIG. 12, the embodiment of the disclosure also provides a chip 70 that may correspond to a UE in the embodiment of the disclosure. The chip 70 may implement a corresponding process realized by the UE in various methods of the embodiments of the disclosure. The chip 70 includes a processor 71, and the processor 71 may call and run a computer program from memory to implement the methods in the embodiments of the present application.

Optionally, the chip 70 may also include a memory 72. In particular, the processor 71 may call and run the computer program from the memory 72 to implement the methods in the embodiments of the present application.

Moreover, the memory 72 may be a separate device from the processor 71 or may be integrated into the processor 71.

Optionally, the chip 70 may further include an input interface 73. Note that the processor 71 may control the input interface 73 to communicate with other devices or chips, specifically, to obtain messages or data sent by other devices or chips.

Optionally, the chip 70 may further include an output interface 74. Note that the processor 71 may control the output interface 74 to communicate with other devices or chips, specifically, to output messages or data to other devices or chips.

FIG. 13 is a block diagram of an example system 700 for wireless communication according to an embodiment of the present disclosure. Embodiments described herein may be implemented into the system using any suitably configured hardware and/or software. FIG. 13 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB (e.g., BS 20a) 20 may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server 41, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for secure ranging service for execution by a user equipment (UE) that serves as an assistant UE, comprising:
establishing a first sidelink between a first UE and the assistant UE and a second sidelink between the assistant UE and a second UE in response to initiation of a sidelink ranging session between the first UE and the second UE, wherein the first sidelink and the second sidelink are secured;
initiating a first sidelink ranging session between the first UE and the assistant UE and a second sidelink ranging session between the assistant UE and the second UE;
generating a binding key;
binding the first sidelink ranging session and the second sidelink ranging session using the binding key;
transmitting the binding key to first UE and to second UE;
performing a first sidelink ranging operation for the first UE and the assistant UE and a second sidelink ranging operation for the second UE and the assistant UE;
obtaining a second interim ranging result of the second sidelink ranging operation; and
transmitting the second interim ranging result to the first UE through the first sidelink ranging session that is bound with the second sidelink ranging session, wherein the second interim ranging result of the second sidelink ranging operation and a first interim ranging result of the first sidelink ranging operation are used for deriving of a final ranging result for the first UE and the second UE.

2. The method for secure ranging service of claim 1, further comprising:
using the binding key and the second interim ranging result to generate a message authentication code (MAC) of the second interim ranging result; and
transmitting the message authentication code to the first UE.

3. The method for secure ranging service of claim 1, wherein the first sidelink and the second sidelink are secured using credentials configured in the first UE, assistant UE, and second UE

4. The method for secure ranging service of claim 1, wherein the assistant UE are provisioned with parameters needed for ranging/Sidelink Positioning services.

5. The method for secure ranging service of claim 4, wherein the parameters include parameters needed to discover other UEs that are capable of ranging and are authorized for ranging services.

6. The method for secure ranging service of claim 4, wherein the parameters include security parameters to secure the PC5 links for the first UE, the second UE, and the assistant UE.

7. The method for secure ranging service of claim 1, wherein before the establishing, the method comprises:
discovering the first UE and the second UE.

8. The method for secure ranging service of claim 7, wherein the assistant UE discovers at least one of the first UE or the second UE through a UE-to-UE relay.

9. The method for secure ranging service of claim 8, wherein security is established for a first PC5 link between the first UE and the UE-to-UE relay and for a second PC5 link between the UE-to-UE relay and the second UE.

10. The method for secure ranging service of claim 1, further comprising:
using a first encryption key to protect the first sidelink between the first UE and the assistant UE; and
using a second encryption key to protect the second sidelink between the assistant UE and a second UE.

11. The method for secure ranging service of claim 10, wherein the binding key is a random number or a cryptographic hash of the first encryption key and the second encryption key.

12. The method for secure ranging service of claim 1, wherein the binding comprises:
using the binding key to encrypt content of the first sidelink ranging session and content of the second sidelink ranging session; or
using the binding key and a cryptographic hash to sign the first sidelink ranging session and the second sidelink ranging session.

13. The method for secure ranging service of claim 12, wherein the cryptographic hash is a cryptographic hash of a session identifier (ID) of the first sidelink ranging session between the first UE and the assistant UE, a session ID of the second sidelink ranging session between the assistant UE and the second UE, and a session ID of a main sidelink ranging session between the first UE and the second UE.

14. A user equipment (UE) comprising:
a memory configured to store a computer program; and
a processor configured to call and run the computer program stored in the memory, to cause a device in which the processor is installed to:
establish a first sidelink between a first UE and an assistant UE and a second sidelink between the assistant UE and a second UE in response to initiation of a sidelink ranging session between the first UE and the second UE, wherein the first sidelink and the second sidelink are secured;
initiate a first sidelink ranging session between the first UE and the assistant UE and a second sidelink ranging session between the assistant UE and the second UE;
generate a binding key;
bind the first sidelink ranging session and the second sidelink ranging session using the binding key;
transmit the binding key to first UE and to second UE;
perform a first sidelink ranging operation for the first UE and the assistant UE and a second sidelink ranging operation for the second UE and the assistant UE;
obtain a second interim ranging result of the second sidelink ranging operation; and
transmit the second interim ranging result to the first UE through the first sidelink ranging session that is bound with the second sidelink ranging session, wherein the second interim ranging result of the second sidelink ranging operation and a first interim ranging result of the first sidelink ranging operation are used for deriving of a final ranging result for the first UE and the second UE.

15. A system for secure ranging service comprising:
a first user equipment (UE) configured for requesting initiation of a sidelink ranging session for the first UE;
a second UE configured for serving as a target UE for the sidelink ranging session; and
an assistant UE configured for establishing a first sidelink between the first UE and the assistant UE and a second sidelink between the assistant UE and a second UE in response to initiation of the sidelink ranging session between the first UE and the second UE, wherein the first sidelink and the second sidelink are secured;
wherein the first UE or the assistant UE initiates a first sidelink ranging session between the first UE and the assistant UE;
the assistant UE initiates a second sidelink ranging session between the assistant UE and the second UE;
the assistant UE generates a binding key;
the assistant UE binds the first sidelink ranging session and the second sidelink ranging session using the binding key;
the assistant UE transmits a binding key to the first UE and to the second UE;
the first UE or the assistant UE performs a first sidelink ranging operation for the first UE and the assistant UE;
the second UE or the assistant UE performs a second sidelink ranging operation for the second UE and the assistant UE;
the assistant UE obtains a second interim ranging result of the second sidelink ranging operation;
the assistant UE uses the binding key and the second interim ranging result to generate a message authentication code (MAC) of the second interim ranging result; and
the assistant UE transmits the message authentication code and the second interim ranging result to the first UE, wherein the second interim ranging result of the second sidelink ranging operation and a first interim ranging result of the first sidelink ranging operation are used for deriving of a final ranging result for the first UE and the second UE;
the first UE receives the message authentication code and the second interim ranging result and uses the message authentication code to validate the second interim ranging result; and
the first UE uses the first interim ranging result and the second interim ranging result to derive the final ranging result for the first UE and the second UE when the second interim ranging result passes validation.

16. The system for secure ranging service of claim 15, wherein the first sidelink and the second sidelink are secured using credentials configured in the first UE, assistant UE, and second UE.

17. The system for secure ranging service of claim 15, wherein the assistant UE are provisioned with parameters needed for ranging/Sidelink Positioning services.

18. The system for secure ranging service of claim 17, wherein the parameters include parameters needed to discover other UEs that are capable of ranging and are authorized for ranging services.

19. The system for secure ranging service of claim 17, wherein the parameters include security parameters to secure the PC5 links for the first UE, the second UE, and the assistant UE.

20. The system for secure ranging service of claim 15, wherein before the establishing, the assistant UE discovers the first UE and the second UE.

21-26. (canceled)
